(19) United States
(12) Patent Application Publication
(10) Pub. No.: US 2009/0114300 A1
(43) Pub. Date: May 7, 2009

(54) FIRE HOSE WITH OUTER INDICATION TEXTURES AND INNER FLOW GUIDE TEXTURES

(76) Inventor: Shyuan-Han Shyu, Taipei County (TW)

Correspondence Address: Shyuan-Han Shyu, 235 Chung - Ho Box 8-24, Taipei, 235, TW

(21) Appl. No.: 11/934,093

(22) Filed: Nov. 2, 2007

(51) Int. Cl. F15D 1/04; F16L 55/00

(52) U.S. Cl. 138/39; 138/104; 138/38; 138/109

(57) ABSTRACT

A fire hose comprises a flexible tube; an inner liner installed to an inner wall of the flexible tube; a surface of the inner liner having a plurality of flow guide textures which are formed along an axial direction of the hose; the flow guide textures protruding or recessed from the surface of the inner liner with a high between 0.5 to 2 mm; and at least one indication texture being formed on the outer surface of the fire hose. Preferably, there are two indication textures which are arranged at two edges at the fire hose is flat as a sheet.

### FIELD OF THE INVENTION

The present invention relates to a fire hose with at least one indication texture for indication of the hose at dark area or at night and with flow guide textures in the inner liner of the hose for guiding the waterflow within the fire hose.

### BACKGROUND OF THE INVENTION

Fire fighting equipments, such as fire alarms, smoke detectors, auto-spraying devices, etc., are widely installed in buildings for extinguishing fire in fire accidents. In general, these devices are installed at some corners of the buildings, which can not keep the attentions of the users. However in fire accident, people often feel nervous so that they can not take these devices rapidly and immediately. As a result, the first response time is lost and it results that the fire accident expands, in some states, it will induce a great lose, even some people dies and asset will suffer from a great lose.

Furthermore, generally, the water in fire hose has very high pressure and will make the fire hose lose of control. As a result, the water spraying direction can not be well controlled so that the effect of fire extinguish is lowered.

### SUMMARY OF THE INVENTION

Accordingly, the primary object of the present invention is to provide a fire hose with at least one indication texture for indication of the hose at dark area or at night and with flow guide textures in the inner liner of the hose for guiding the waterflow within the fire hose.

To achieve above objects, the present invention provides a fire hose comprising: a flexible tube; an inner liner installed to an inner wall of the flexible tube; a surface of the inner liner having a plurality of flow guide textures which are formed along an axial direction of the hose; the flow guide textures protruding or recessed from the surface of the inner liner with a high between 0.5 to 2 mm; and at least one indication texture being formed on the outer surface of the fire hose. The flexible tube has two ends which are connected to a female joint and a male joint, respectively; the male joint can be pivoted to another female joint with the same type; the female joint can be pivoted to another male joint with the same type so that the length of the fire hose can be extended unlimitedly. The flexible tube is made of intereweaverd or non-interweaved gunny or synthetic fiber cloth. There are two indication textures which are especially apparent at night. The indication texture are at two edges at the fire hose is flat as a sheet. The materials of the indication textures are selected from sulfide or rare earth computer which contain Zns:Cu, or ZnCds:Cu.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a cross sectional view of the hose of the present invention.

FIG. 3 is a perspective view showing that the fire hose is wound as a cylinder.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to drawings, the fire hose of the present invention has the following elements.

A flexible tube 1 has two ends which are connected to a female joint 12 and a male joint 13, respectively. The male joint 13 and female joint 12 are rapid-connected joints. The male joint 13 can be pivoted to another female joint 12 with the same type. The female joint 12 can be pivoted to another male joint 13 with the same type so that the length of the fire hose can be extended unlimitedly.

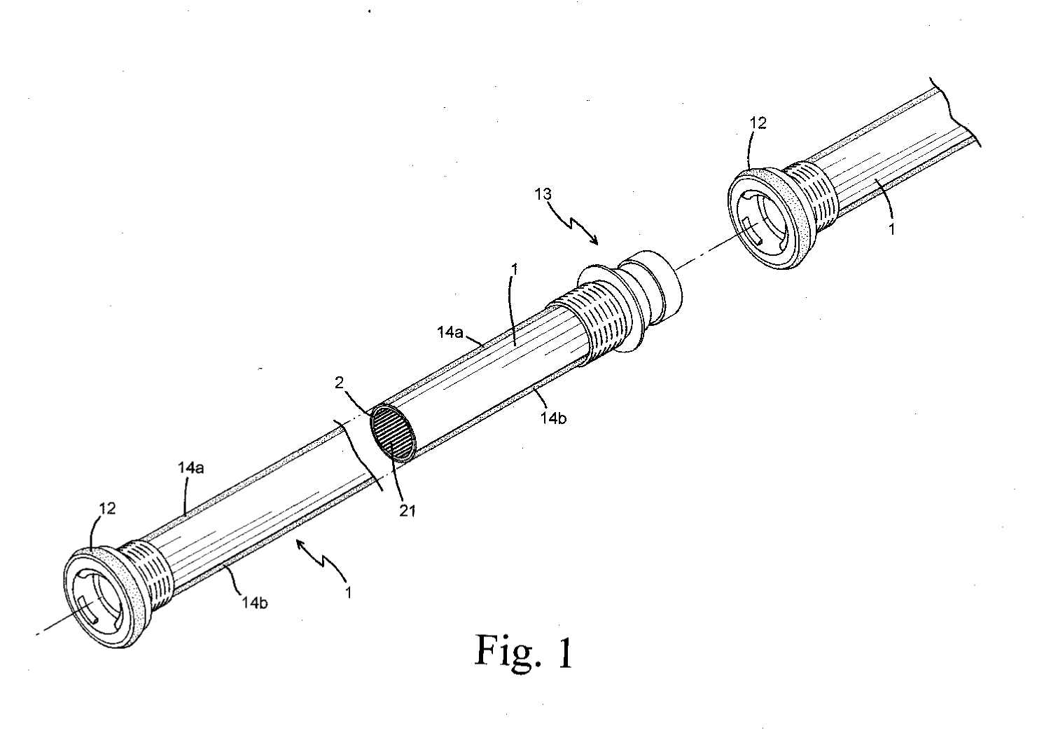

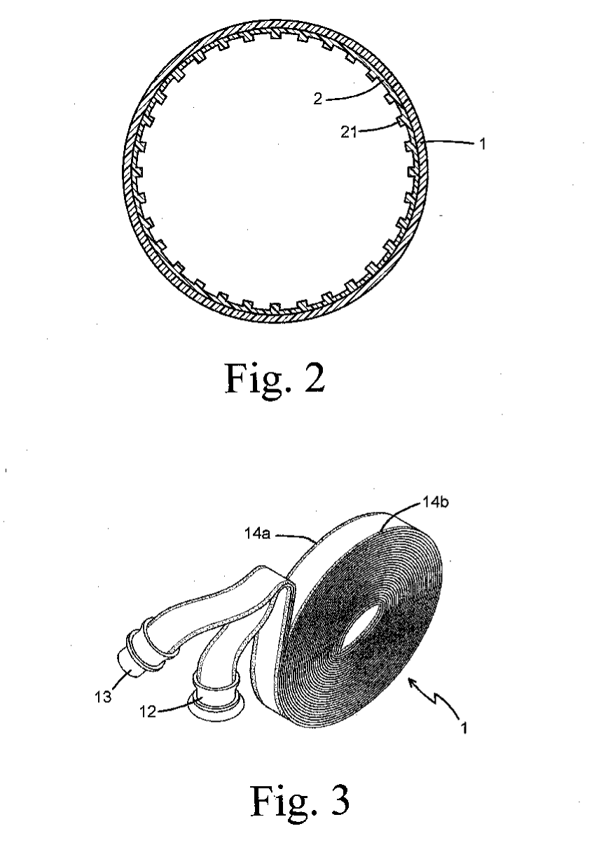

The flexible tube 1 is made of intereweaverd or non-interweaved gunny or synthetic fiber cloth, which are strong, wear endurable and fireproof. The flexible tube 1 can be flated radially so as to be wound as a cylinder. Referring to FIGS. 1 and 2, an outer surface of the flexible tube 1 are axially formed with two indication textures 14a, 14b which are especially apparent at night. The indication texture 14a and indication texture 14b are at two edges at the fire hose is flat as a sheet. When the fire hose is wound as a cylinder the indication texture 14a and indication texture 14b are at two ends of the cylinder so as to present the indication textures (referring to FIG. 3). Furthermore, the indication textures are made of light emitting fiber which is mixed in the fire hose in manufacturing so that they will not fall out. Preferable, the materials of the indication textures are selected from sulfide or rare earth components which contain Zns:Cu (emitting green light), or ZnCds:Cu (emitting yellow light) so as to have high light intensity and long emitting time. Thus at night, the indication textures can be seen. Thus in choas, people can find the fire hose easily.

Referring to FIG. 2, an inner liner 2 is adhered to an inner wall of the flexible tube 1. A surface of the inner liner 2 is installed with a plurality of flow guide textures 21 which protrude or recessed from the surface of the inner liner 2 with a length of 0.5˜2 mm for guiding high pressure water within the fire hose so that the fire hose can be well controlled as water is transferred in the fire hose and thus the spray direction of the water can be well controlled.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fire hose comprising:
a flexible tube;
an inner liner installed to an inner wall of the flexible tube; a surface of the inner liner having a plurality of flow guide textures which are formed along an axial direction of the hose; the flow guide textures protruding or recessed from the surface of the inner liner with a high between 0.5 to 2 mm;
at least one indication texture being formed on an outer surface of the fire hose.

2. The fire hose as claimed in claim 1, wherein the flexible tube has two ends which are connected to a female joint and a male joint, respectively; the male joint can be pivoted to another female joint with the same type; the female joint can be pivoted to another male joint with the same type so that the length of the fire hose can be extended unlimitedly.

3. The fire hose as claimed in claim 1, wherein the flexible tube is made of intereweaverd or non-interweaved gunny or synthetic fiber cloth.

4. The fire hose as claimed in claim 1, wherein there are two indication textures which are especially apparent at night.

5. The fire hose as claimed in claim 1, wherein the indication texture are at two edges at the fire hose and is flat as a sheet.

6. The fire hose as claimed in claim 1, wherein the materials of the indication textures are selected from sulfide or rare earth component which contain Zns:Cu, or ZnCds:Cu.
